(19) United States
(12) Patent Application Publication
(10) Pub. No.: US 2005/0116839 A1
(43) Pub. Date: Jun. 2, 2005

(54) System for communicating environmental conditions of a vehicle

(76) Inventor: Charles Warren, Fennville, MI (US)

Correspondence Address: ROBERT J. SAYFIE, P.C., 161 OTTAWA AVENUE NW, SUITE 407, GRAND RAPIDS, MI, 49503, US

(21) Appl. No.: 10/944,087

(22) Filed: Sep. 17, 2004

Related U.S. Application Data
(60) Provisional application No. 60/503,341, filed on Sep. 17, 2003.

(51) Int. Cl. G08B 23/00

(52) U.S. Cl. 340/984; 340/531

(57) ABSTRACT

An boat alarm system comprising a remote transmitter having a sensor and a transmitter antenna; a land-based station having a station antenna; and whereby said sensor, in response to a condition, triggers the remote transmitter to transmit a first signal via said transmitter antenna, said first signal is received by said land-based station via a station antenna, said land-based station then sends a second signal that calls a predesignated phone number.

### CROSS-REFERENCE TO RELATED APPLICATION

This application claims the benefit of U.S. Provisional Patent Application Ser. No. 60/503,341, filed 17 Sep. 2003, which is incorporated herein by reference.

### FIELD OF THE INVENTION

The invention relates to a system whereby a transmitter located on a boat sends a first signal to a land based receiving unit, which calls a designated phone number.

### BACKGROUND OF THE INVENTION

While docked and unmanned, boats sink for a variety of reasons. Some of the reasons include failure of underwater fittings, rain and snow, failure of fittings above the waterline, and poor docking arrangements. Other damage can occur from fire, theft, breakage, or intrusion. This causes further damage to the boat, equipment, and the environment. Sometimes the boat is a total loss. For each boat that sinks while manned at sea, it is estimated that four unmanned boats sink while docked. While docked, even a very slow leak can sink a boat. Early warning can prevent most boats from sinking.

Many problems in unattended boats or vehicles are unnoticed until the owner or other personnel is present, which may be weeks or months after any damage begins. This is a long enough time period in which extensive damage can occur. Damage that could have been prevented by early detection of the problem and the communication of the presence of the problem to the owner, or other personnel capable of preventing further damage, or correcting the problem.

There exists a need to quickly warn an unmanned boat owner that the boat is in danger. The boat owner can then take some action to mitigate any boat damage or to otherwise remedy the problem. The boat owner can contact an appropriate marina employee, salvage company, or other similar personnel.

Multiple embodiments of the system are disclosed herein. It will be understood that other objects and purposes of the invention, and variations thereof, will be apparent upon reading the following specification and inspecting the accompanying drawings.

### BRIEF SUMMARY OF THE INVENTION

The present invention solves the problems of unmanned boat sinking. Use of the applicant's invention enables the boat owner to be notified of a boat in danger. The boat owner can then mitigate any potential problem.

The system comprises components including (1) a remote transmitter having a sensor that activates transmission of a first signal to a land-based station, (2) the land-based station sends a second signal via a cellular or plain old telephone system (POTS) telephone lines for communication to a telephone. After the boat caretaker answers the phone, the phone is used to send a confirmation signal back to the land-based station so that the land-based station is turned off.

The remote transmitter is powered by its own battery that also signals the land-based station to alert the boat caretaker, so that the battery can be replaced. Alternatively they can be solar powered, powered by fuel cells, or plugged into a standard electrical outlet.

### BRIEF DESCRIPTION OF THE DRAWINGS

FIG. 1 is a pictorial view of the remote transmitter.

FIG. 2 is a pictorial view of the land-based station.

FIG. 3 is a schematic of the system.

Certain terminology will be used in the following description for convenience and reference only, and will not be limiting. For example, the words “upwardly,” “downwardly,” “rightwardly,” and “leftwardly” will refer to directions in the drawings to which reference is made. The words “inwardly” and “outwardly” will refer to directions toward and away from, respectively, the geometric center of the system and designated parts. Said terminology will include the words specifically mentioned, derivatives, and similar words.

### DETAILED DESCRIPTION

Referring to FIG. 1, a remote transmitter 10 is illustrated. The remote transmitter 10 is securely mounted on a boat. The remote transmitter 10 comprises a housing. In one embodiment the housing is impermeable to water. The remote transmitter 10 comprises an environmental or system sensor that interprets conditions or alerts on the boat by use of sensors. The conditions include flooding, intrusion, motion, heat, smoke, high water, low voltage, battery power, level or position of the boat, and depth of the boat. Different or additional sensors can be utilized. The remote transmitter 10 is powered by its own battery. Other power options include the use of solar power, or the remote transmitter 10 can be wired to the boat's power system. Another embodiment uses the boat's own power with a battery backup.

The remote transmitter 10 receives a sensor signal from a sender or sensor mounted within the boat or vehicle. The sensor or sender is triggered by adverse conditions such as changes in environmental conditions, such as, but not limited to, heat, smoke, intrusion, high water, or low voltage. The remote transmitter 10 receives a sensor signal from the sensor or sender, and transmits a first signal including a unique identifier to the land-based station 20, which is mounted away from the boat or vehicle. The land-based station 20 can be positioned in a marina, office, or home.

The remote transmitter 10 first signal is sent via a transmitter antenna 80, to a land-based station 20. The transmitter antenna 80 uses radio frequency (RF). Another embodiment has the antenna disposed within the housing 12. In a further embodiment, the antenna 80 does not use RF, but other means to send a signal, such as infrared, laser, or cellular technology.

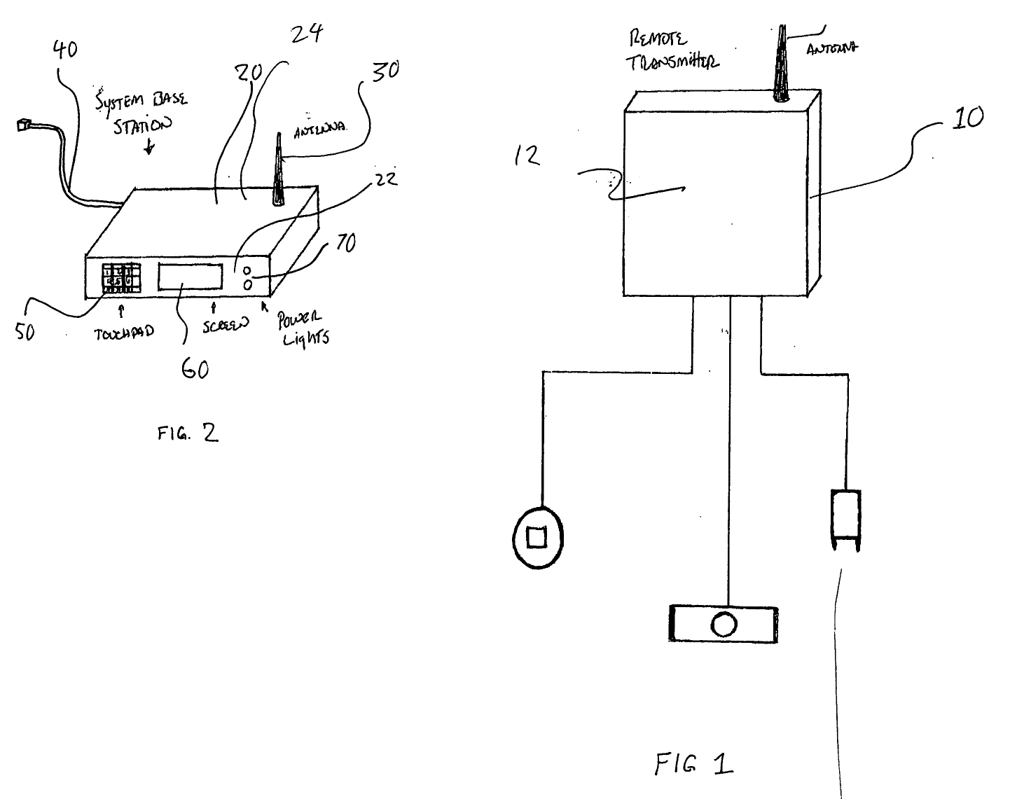

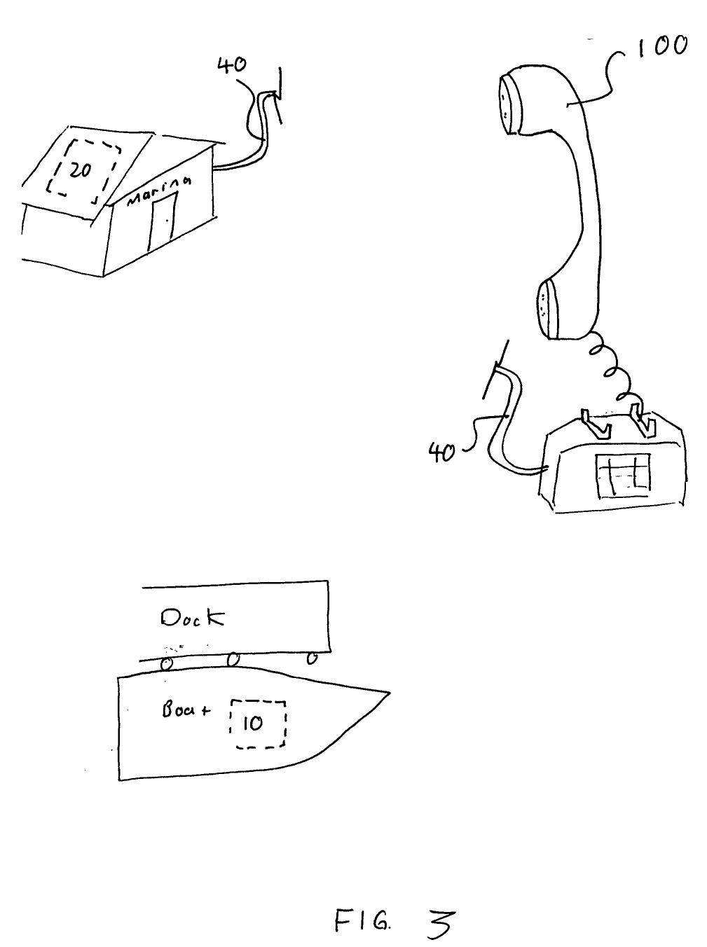

Referring to FIG. 2, the land-based station 20 is illustrated. The land-based station 20 has a transceiver unit that receives the first signal from the remote transmitter 10, and the land-based station 20 sends a second signal to a land line telephone 100 via plain old telephone system (POTS). In another embodiment the land-based station 20 sends a second signal via cellular technology. The land-based station 20 is disposed in a marina or a house.

The land-based station 20 comprises a housing having a front face 22. The front face 22 has a keypad 50 disposed thereon whereby the user can program the land-based station 20. The keypad has the same numbering system as a standard telephone. The front face 22 also has a screen 60 whereby the user can view information. The screen is also used for verification of manually entered information. This information includes those numbers entered by the keypad 50 or other status information. In a separate embodiment, no keypad 50 exists, and a touch-screen is used as the interface for receiving or programming, and also for display. The front face 22 also has indicator lights 70 to designate “on” and the alert or tocsin status. The alert status exists, and thus the light is on when the land-based station 20 is sending the second signal to the telephone 100.

A base antenna 30 extends from the land-based station 20. The base antenna 30 is used to receive the first signal from the remote transmitter 10, thus also uses radio frequency (RF). However, in a separate embodiment, the base antenna 30 does not use RF, but other signal means, such as laser, infrared, or cellular technology. The land-based station 20 also has a telephone line 40. The second signal is sent via the telephone line 40 or via the antenna 30.

In a further embodiment the base antenna 30 is used to receive the first signal, whether it be by laser, infrared, cellular, or other technology, and send the second signal via cellular technology. In a further embodiment, whether the second signal is sent via the telephone line 40 or the antenna 30 is determined by a pre-set switch on the housing of the land-based station 20

In a further embodiment, a sensor within the land-based station 20 determines whether the second signal is sent via the telephone line 40 or the antenna 30, based on the cellular phone reception that the land-based station utilizes in this embodiment.

Referring to FIG. 3, a schematic showing the remote transmitter 10 disposed on a boat, a land-based station 20 located in a marina, and a telephone 100

In a further embodiment, the land-based station 20 incorporates LED's as the indicator lights 70.

Other embodiments of the keypad 50 have more or less buttons.

The land-based station 20 is designed to be placed on a desk, and plugged into an electrical outlet. In a further embodiment, it is battery powered. In yet a further embodiment, it is powered by the electrical outlet, with battery backup.

On a bottom face of the land-based station 20 are rubber standoffs so the land based station does not move easily once positioned on a surface such as a counter or table.

The antennas 80, 30 are connected within the housing 12, 24, respectively to the applicable component, such as a transceiver.

In a further embodiment the land-based station 20 can receive first signals from several different remote transmitters 10. Each remote transmitter 10 has a distinct identifier.

The operation of the system is as follows. The land-based station 20 can be manually programmed by the touchpad 70, with a list of telephone or pager numbers of designated contact personnel. In a separate embodiment the programming can be performed on a computer such as a PC, whereby the land-based station can have a USB port for connection with a PC. The list of contact numbers is retained by the land-based station 20 until manually changed by the end-user. In a separate embodiment, the numbers can be changed remotely, by calling the land-based station 20 via a phone, or via a PC. Once a certain condition is detected, the first signal is sent by the remote transmitter 10 to the land-based station 20. Then the land-based station 20 calls a predesignated phone number. If there is no answer after a certain number of rings, or within a certain time period, or if the phone is answered, but a correct confirmation code or PIN number is not entered, then, if programmed into the land-based station, a second phone number is dialed. This succession can continue for any quantity of phone numbers, and then it would start from the beginning again.

Once the phone 100 is answered, the land-based station 20 conveys a pre-recorded message, or a particular sound or sounds. Then the person who answered manually enters the correct confirmation code or PIN number by pressing the keys on the phone, then the land-based station 20 stops dialing the predesignated phone numbers that were programmed for that particular remote transmitter 10. The entry of the confirmation code or PIN number verifies that the personnel who answered the call received the message and understand the alert call. The personnel can then take appropriate action to mitigate or eliminate any problem.

Although the system is used primarily for boats, it can also be utilized by recreational vehicles and other novel uses.

This system can be made and used as a single use unit for home users with a single boat. Also the land-based station 20 can be made and used as a unit capable of responding to signals from multiple remote transmitters 10, as in the case of marinas or recreational vehicle parks. For example, if a different remote transmitter 10′ also sends a different first signal to the same land-based station 20, then the land-based station also calls a predesignated phone number, or phone numbers. This way, one marina can have one land-based station 20 on site, and service several boats, each boat with a different remote transmitter 10. Each remote transmitter 10 would have a different identifier in this embodiment.

1. A boat alarm system comprising:
a remote transmitter having a transmitter antenna;
a land-based station having a station antenna; and
whereby a sensor disposed in a boat, triggers said remote transmitter to transmit a first signal via said transmitter antenna, said first signal is received by said land-based station via said station antenna, said land-based station then sends a second signal that calls a predesignated phone number.

2. The boat alarm system of claim 1, further comprising:
said land-based station being programmable via a touchpad that is disposed on a front face of said land-based station for programming said predesignated phone numbers.

3. The boat alarm system of claim 1, further comprising:
said land-based station having a screen disposed on a front face for displaying data.

4. The boat alarm system of claim 1, further comprising:
said land-based station having an indicator light disposed on a front face.

5. The boat alarm system of claim 1, further comprising:
said land-based station having a housing, said housing containing a phone line jack for receiving a phone line, whereby said land-based station uses the phone line to send said second signal and call said predesignated phone number.

6. The boat alarm system of claim 1, further comprising:
said land-based station having a cellular antenna to send said second signal to a predesignated phone number via cellular technology.

7. The emergency alert system of claim 1, further comprising:
said first signal being a radio frequency signal.

8. The boat alarm system of claim 1, further comprising:
said remote transmitter being in a boat.

9. The boat alarm system of claim 1, further comprising:
said land-based station being positioned off of a boat.

10. The boat alarm system of claim 1, further comprising:
said land-based station being positioned in a marina.

11. The boat alarm system of claim 1, further comprising:
said remote transmitter being hermetically sealed.

12. The boat alarm system of claim 1, further comprising:
said remote transmitter being powered by a battery.

13. The boat alarm system of claim 1, further comprising:
said land-based station being powered by a battery.
